(19) United States
(12) Patent Application Publication
(10) Pub. No.: US 2011/0112842 A1
(43) Pub. Date: May 12, 2011

(54) METHOD AND APPARATUS FOR EDITING AUDIO OBJECT IN SPATIAL INFORMATION-BASED MULTI-OBJECT AUDIO CODING APPARATUS

(75) Inventors: Jeongil Seo, Daejeon (KR); Seungkwon Beack, Daejeon (KR); Kyeongok Kang, Daejeon (KR); Jin Woo Hong, Daejeon (KR); Jinwoong Kim, Daejeon (KR); Chieteuk Ahn, Daejeon (KR); Kwangki Kim, Daejeon (KR); Minsoo Hahn, Daejeon (KR)

(73) Assignee: Electronics and Telecommunications Research Institute, Daejeon (KR)

(21) Appl. No.: 13/003,160

(22) PCT Filed: Jul. 10, 2009
(86) PCT No.: PCT/KR2009/003795

§ 371 Date: Jan. 7, 2011

(30) Foreign Application Priority Data
Jul. 10, 2008 (KR) 10-2008-0067096
Jul. 7, 2009 (KR) 10-2009-0061636

(51) Int. Cl. G10L 19/00

(52) U.S. Cl. 704/500; 704/E19.001

(57) ABSTRACT

Disclosed is an audio object editing apparatus of a multi-object audio coding apparatus. The audio object editing apparatus of the multi-object audio coding apparatus may include an object information extracting unit to receive an object bit stream and to extract object information from the object bit stream, a downmix processing unit to receive a downmix signal, and to control the downmix signal using object editing information and the object information, and a bit stream processing unit to edit the object information according to the object editing information, and to generate a controlled object bit stream based on the edited object information.

### TECHNICAL FIELD

The present invention relates to an object-based audio coding method and apparatus that effectively compresses an audio object signal, and more particularly, to a method of editing an existing object signal by using a multi-object bit stream and a downmix signal generated through coding with respect to input objects in a multi-object audio decoding unit without another coding process.

### BACKGROUND ART

Technologies of coding an object-based audio are for effectively compressing an audio object signal.

A conventional object-based audio coding technology may need to perform coding again with respect to an object to be edited when editing the object, the editing including correcting, deleting, adding of the object, and the like.

In particular, when a conventional multi-object audio decoding unit corrects or deletes an object, another coding process needs to be performed using an original object signal. Also, when another object is added, coding with respect to the original object signal and an object signal of the other object to be added also needs to be performed.

Accordingly, there is a difficulty in that the original object signal is always required when editing the object, and also there is a problem of an increase in complexity since a coding process is required to be performed again.

Accordingly, there is need for an apparatus or a method that may edit the object without the original object signal or may edit the object without performing the coding process again.

### DISCLOSURE OF INVENTION

### Technical Goals

An aspect of the present invention provides an audio object editing apparatus in a multi-object audio coding apparatus, the apparatus may edit an existing object signal by using a multi-object bit stream and a downmix signal generated through coding with respect to inputted objects in a multi-object audio decoding unit, thereby enabling editing of an audio object without having an original object signal.

Another aspect of the present invention also provides an audio object editing apparatus in a multi-object audio coding apparatus, the apparatus may edit an existing object signal by using a multi-object bit stream and a downmix signal generated through coding with respect to inputted objects in a multi-object audio decoding unit without performing a coding process with respect to the object to be edited.

### Technical Solutions

According to an aspect of an exemplary embodiment, there is provided an audio object editing apparatus in a multi-object audio coding apparatus, the apparatus including an object information extracting unit to receive an object bit stream and to extract object information from the object bit stream, a downmix processing unit to receive a downmix signal, and to control the downmix signal using object editing information and the object information, and a bit stream processing unit to edit the object information according to the object editing information, and to generate a controlled object bit stream based on the edited object information.

According to another aspect of an exemplary embodiment, there is provided audio object edition apparatus in a multi-object audio coding apparatus, the method including a bit stream handler to receive an object bit stream, and to extract, from the object bit stream, a background object (BGO) bit stream indicating a background music and a foreground object bit stream indicating a predetermined object signal, an object generating unit to receive a downmix signal, and to generate a BGO downmix signal and a foreground object (FGO) using the BGO bit stream, the FGO bit stream, and the downmix signal, a downmix controlling unit to control the BGO downmix signal and the FGO according to object editing information, and to generate a controlled downmix signal by mixing the controlled BGO downmix signal and the controlled FGO, a bit stream controlling unit to edit the BGO bit stream and the FGO bit stream according to the object editing information, and a bit stream formatter to generate a controlled bit stream by synthesizing the BGO bit stream and the FGO bit stream which are edited by the bit stream controlling unit.

### Advantageous Effects

Embodiments of the present invention may edit an existing object signal by using a multi-object bit stream and a downmix signal generated through coding with respect to inputted objects in a multi-object audio decoding unit, thereby enabling edit of an audio object without having an original object signal.

Embodiments of the present invention may edit an existing object signal by using a multi-object bit stream and a downmix signal generated through coding with respect to inputted objects in a multi-object audio decoding unit without performing coding process with respect to the object to be edited.

### BRIEF DESCRIPTION OF DRAWINGS

FIG. 1 illustrates an example of a multi-object audio coding apparatus where an audio object editing apparatus is combined according to an embodiment of the present invention;

FIG. 2 is a diagram roughly illustrating an audio object editing apparatus in a multi-object audio coding apparatus according to an embodiment of the present invention;

FIG. 3 is a flowchart illustrating an audio object edition method in a multi-object audio coding apparatus according to an embodiment of the present invention;

FIG. 4 is a diagram roughly illustrating an audio object editing apparatus in a multi-object audio coding apparatus according to another embodiment of the present invention; and

FIG. 5 is a flowchart illustrating an audio object editing method in a multi-object audio coding apparatus according to another embodiment of the present invention.

### BEST MODE FOR CARRYING OUT THE INVENTION

Although a few exemplary embodiments of the present invention have been shown and described, the present invention is not limited to the described exemplary embodiments, wherein like reference numerals refer to the like elements throughout.

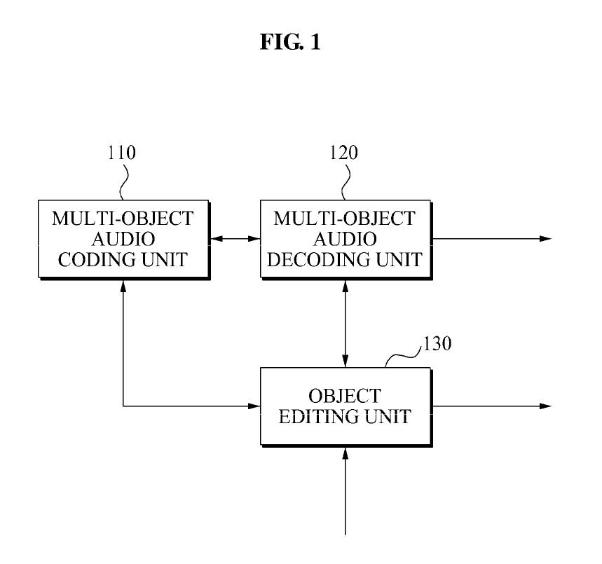

FIG. 1 illustrates an example of a multi-object audio coding apparatus where an audio object editing apparatus is combined according to an embodiment of the present invention.

According to an embodiment of the present invention, the multi audio coding apparatus where the audio object editing apparatus is combined may include a multi-object audio coding unit 110, a multi-object audio decoding unit 120, and an object editing unit 130 as illustrated in FIG. 1.

The multi-object audio coding unit 110 generates an object bit stream that is additional information indicating information of a downmix signal and information of each object by performing coding with respect to inputted multi-object signal, and transmits the generated object bit stream to the multi-object audio decoding unit 120 and the object editing unit 130.

The multi-object audio decoding unit 120 may restore the multi-object signal using the object bit stream and the downmix signal transmitted from the multi-object audio coding unit 110.

The object editing unit 130 may perform editing, such as correcting, deleting, and adding, the object by using the downmix signal and the object bit stream transmitted from the multi-object audio coding unit 110.

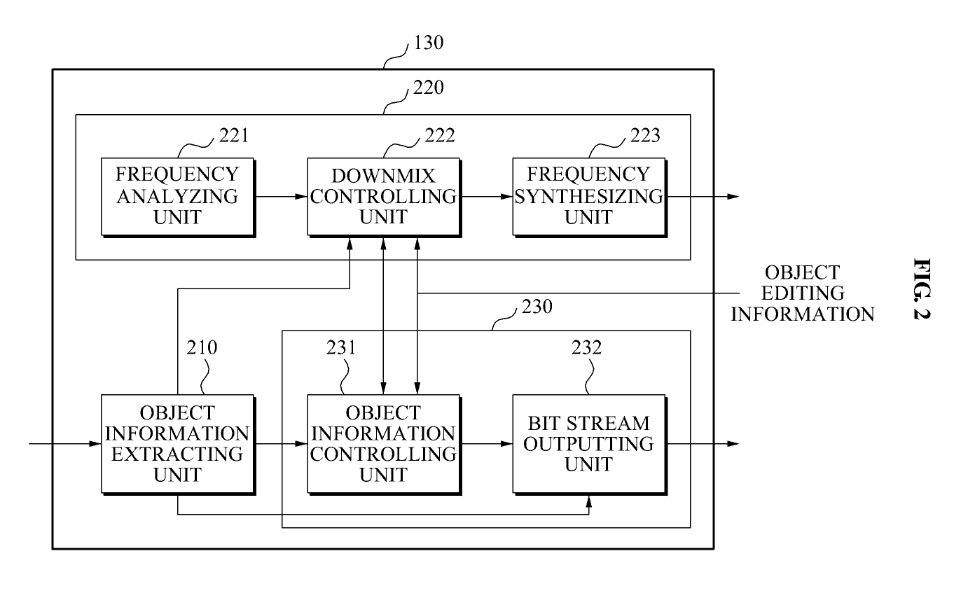

FIG. 2 is a diagram roughly illustrating an audio object editing apparatus in a multi-object audio coding apparatus according to an embodiment of the present invention.

Referring to FIG. 2, the audio object editing apparatus in the multi-object audio coding apparatus according to an embodiment of the present invention may include an object information extracting unit 210, a downmix processing unit 220, and a bit stream processing unit 230.

The object information extracting unit 210 may receive the object bit stream transmitted from the multi-object audio coding unit 110, may extract object information from the object bit stream, and may transmit the extracted object information to the downmix processing unit 220 and the bit stream processing unit 230.

In this instance, the object information extracted by the object information extracting unit 210 is a parameter used as additional information indicating information of each object in a multi-object audio coding technology, and the object information may include at least one of an object level difference (OLD) indicating a difference in a size between objects, an inter-object correlation (IOC) indicating a correlation between the objects, a downmix gain (DMG) indicating an degree of control of a signal level when each object is downmixed, and a downmix channel level difference (DCLD) indicating a power ratio between a left side and a right side of a stereo object signal.

Also, the object information may be extracted by a sub-band unit in a frame structure that includes 20 or 28 sub-bands according to a frequency resolution.

The downmix processing unit 220 may receive a downmix signal transmitted from the multi-object audio coding unit 110, and may control the downmix signal by using object editing information and the object information.

The downmix processing unit 220 may include a frequency analyzing unit 221, a downmix controlling unit 222, and a frequency synthesizing unit 223.

The frequency analyzing unit 221 may transform the downmix signal transmitted from the multi-object audio coding unit 110 to a downmix signal of a frequency domain.

The downmix controlling unit 222 may generate a controlled downmix signal of the frequency domain by editing, such as correcting, adding, deleting, or substituting, a predetermined object signal. In this instance, the predetermined object signal may be a signal included in the downmix signal of the frequency domain transformed by the frequency analyzing unit 221.

The frequency synthesizing unit 223 may generate a controlled downmix signal by transforming the controlled downmix signal of the frequency domain to the controlled downmix signal, and may transmit the controlled downmix signal.

The bit stream processing unit 230 may edit the object information according to object editing information, and may generate a controlled object bit stream based on the edited object information.

The bit stream processing unit 230 may include an object information controlling unit 231 and a bit stream outputting unit 232 as illustrated in FIG. 2.

The object information controlling unit 231 may edit the object information according to the object editing information.

The bit stream outputting unit 232 may generate the controlled bit stream by synthesizing object information controlled by the object information controlling unit 231 and the bit stream, and may transmit the controlled bit stream.

Subsequently, each operation of when the object editing unit 130 corrects, deletes, or adds the object will be described.

First, when the object editing information is correction information for correcting an object, the downmix processing unit 220 changes an OLD of the object corresponding to the correction information among OLDs based on the correction information, and controls the downmix signal according to a ratio between an OLD accumulated value based on the changed OLD and an OLD accumulated value prior to the change. In this instance, the OLD accumulated value may be a sum of each OLD of multiple objects included in a frame.

Particularly, the downmix processing unit 220 may control the downmix signal based on Equation 1 as given below.

$${\hat{P}}_{d} ( n , k ) = {P}_{d} ( n , k ) \cdot \frac{{\sum }_{i = 1 , i \neq m}^{N} {OLD}_{i} ( n , k ) + α \cdot {OLD}_{m} ( n , k )}{{\sum }_{i = 1}^{N} {OLD}_{i} ( n , k )} \qquad [ Equation 1 ]$$

In this instance, N is a total number of objects, n is a frame, k is information for identifying a sub-band included in the frame, and a is a scaling vector indicating an degree of edit for the object.

Also, OLD, is an OLD size of an i^{th} object, OLDₘ is an OLD size to be changed based on the correction information, P_{d} is power of the downmix signal received by the downmix processing unit 220, and \hat{P}_{d} is power of the controlled downmix signal by the downmix processing unit 220.

As an example, when a single frame is composed of four sub-bands, each OLD of the sub-bands is respectively 1, 0.5, 0.7, and 0.4, and the correction information for reducing an OLD of a fourth object by half will be described.

First, the downmix processing unit 220 may calculate an OLD accumulated value prior to change, namely, the sum of an OLD of each object in the frame as 1+0.5+0.7+0.4=2.6.

Subsequently, the downmix processing unit 220 may change the OLD of the fourth object, namely, 0.4, to 0.2 by reducing 0.4 by half, and may calculate an OLD accumulated value including 0.2 that is the changed OLD of the fourth object, as 1+0.5+0.7+0.2=2.4.

Also, the downmix processing unit 220 may reduce power of the downmix signal by 2.4/2.6 that is a ratio between the OLD accumulated value based on the changed OLD, namely, 2.4, and the OLD accumulated value prior to the change, namely, 2.6.

In this instance, the object information controlling unit 231 may change an OLD based on the correction information.

Particularly, the object information controlling unit 231 may change the OLD of the object based on the scaling vector α and a fact that a maximum value of the OLD is 1. Here, the scaling vector indicates an amount of edit for the object to be changed based on the correction information.

In this instance, a method of controlling an OLD with respect to a predetermined sub-band (k) in a predetermined frame (n) is classified into a case of when an OLD of an object corresponding to the correction information is 1 and a case of when the OLD of the object corresponding to the correction information is not 1.

When OLDₘ(n,k) that is the OLD of the object corresponding to the correction information is 1, the object information controlling unit 231 may compare OLDₘ(n,k) with each OLD of remaining objects.

In this instance, when the OLDₘ(n,k) is greater than each OLD of the remaining objects, the object information controlling unit 231 may change each OLD of the remaining objects to satisfy Equation 2 as given below.

$${OLD}_{m , new} ( n , k ) = 1 \\ {OLD}_{i , new} ( n , k ) = \frac{{OLD}_{i , old} ( n , k )}{a * {OLD}_{m} ( n , k )} \qquad [ Equation 2 ]$$

In this instance, OLD_{m,new}(n, k) may be OLDₘ(n, k) to be changed based on the correction information, OLD_{i,new}(n, k) may be a remaining OLD to be changed based on the correction information, and OLD_{i,old}(n, k) may be an OLD inputted from the object information extracting unit 210.

Also, when OLDₛ(n,k) that is an object having an OLD greater than OLDₘ(n,k) exists, the object information controlling unit 231 may change a OLD of each object to satisfy Equation 3 as given below.

$${OLD}_{m , new} ( n , k ) = \frac{a * {OLD}_{m} ( n , k )}{{OLD}_{s} ( n , k )} \\ {OLD}_{i , new} ( n , k ) = \frac{{OLD}_{i , old} ( n , k )}{{OLD}_{s} ( n , k )} \qquad [ Equation 3 ]$$

Also, when OLDₘ(n,k) that is the OLD of the object corresponding to the correction information is not ‘1’, the object information controlling unit 231 may determine whether the OLDₘ(n,k) is greater than ‘1’ or less than ‘1’.

In this instance, when the OLDₘ(n,k) is greater than ‘1’, the object information controlling unit 231 may change the OLD of each object to satisfy Equation 2 as given above.

Also, when the OLDₘ(n,k) is less than ‘1’, the object information controlling unit 231 may change the OLDₘ(n,k) to satisfy Equation 4 as given below, and may not change each OLD of remaining objects.

OLD_{m,new}(n,k)=α*OLDₘ(n,k) [Equation 4]

Subsequently, when the object editing information is deletion information for deleting an object, the downmix processing unit 220 changes an OLD of the object corresponding to the deletion information among all OLDs into ‘0’, and controls a downmix signal according to a ratio between an OLD accumulated value using the changed OLD and an OLD accumulated value prior to the change.

Particularly, the downmix processing unit 220 may control the downmix signal using Equation 5 as given below.

$${\hat{P}}_{d} ( n , k ) = {P}_{d} ( n , k ) \cdot \frac{{\sum }_{i = 1 , i \neq m}^{N} {OLD}_{i} ( n , k )}{{\sum }_{i = 1}^{N} {OLD}_{i} ( n , k )} \qquad [ Equation 5 ]$$

In this instance, Equation 5 may be identical to Equation 1 when ‘0’ is substituted for OLDₘ(n,k).

In this instance, the object information controlling unit 231 may delete the object using an OLD and an IOC.

Particularly, the object information controlling unit 231 may delete an OLD of the object corresponding to the correction information among OLDs, and may change each remaining OLD of remaining objects, and delete at least one IOC related to the object corresponding to the correct information.

When a number of objects for each frame is N, the IOC may be formed as an N×N matrix as given in Equation 6 below, by grouping two frames. Also, the IOC represents a correlation between objects respectively included in two grouped frames.

$$IOC = [ \begin{matrix}{IOC}_{11} & {IOC}_{12} & … & {IOC}_{1 N} \\ {IOC}_{21} & {IOC}_{22} & … & {IOC}_{2 N} \\ … & … & … & … \\ {IOC}_{N 1} & {IOC}_{N 2} & … & {IOC}_{N N}\end{matrix} ] \qquad [ Equation 6 ]$$

Accordingly, when a predetermined object is deleted, an IOC related to the predetermined object becomes superfluous, and thus, the corresponding IOC may be deleted from the IOC matrix.

As an example, when an M^{th} object is deleted, the object information controlling unit 231 may delete an IOC corresponding to M^{th} row and column from the IOC matrix of Equation 6 to generate (N−1)×(N−1) IOC matrix, and the generated (N−1)×(N−1) IOC matrix is stored in a controlled bit stream generated from the bit stream outputting unit 232.

In this instance, a method of controlling an OLD with respect to a predetermined sub-band (k) in a predetermined frame (n) is classified into a case of when an OLD of an object corresponding to the correction information is 1 and a case of when the OLD of the object corresponding to the correction information is not 1.

When the OLD to be deleted is ‘1’, the object information controlling unit 231 may change each remaining OLD of remaining objects to satisfy Equation 7 as given below.

$${OLD}_{i , new} ( n , k ) = \frac{{OLD}_{i , old} ( n , k )}{{OLD}_{s} ( n , k )} \qquad [ Equation 7 ]$$

Also, when the OLD is not ‘1’, the object information controlling unit 231 may not change each remaining OLD of the remaining objects.

Also, the object information controlling unit 231 may delete a DMG and DCLD with respect to a corresponding object in a bit stream.

Also, when the object editing information is addition information including an object to be added, the downmix processing unit 220 may control a downmix signal by mixing the addition information with the downmix signal.

Particularly, the downmix processing unit 220 may control the downmix signal based on Equation 8 as given below.

\hat{P}_{d}(n,k)=P_{d}(n,k)+Pᵢₙₛ(n,k) [Equation 8]

In this instance, the object information controlling unit 231 may generate a controlled OLD and a controlled IOC, based on the addition information, and may change an OLD and an IOC which are extracted from the object information extracting unit 210 to the controlled OLD and the controlled IOC.

In this instance, the object information controlling unit 231 may generate an IOC matrix that satisfies Equation 10 as given below based on Equation 9 as given below.

$$\begin{matrix}{IOC}_{i , k} ( pb ) = {IOC}_{k , i} ( pb ) = Re \{ \frac{{\sum }_{n} {\sum }_{m ∈ pb} {x}_{i}^{n , m} {x}_{k}^{n , {m}^{*}}}{\sqrt{{\sum }_{n} {\sum }_{m ∈ pb} {x}_{i}^{n , m} {x}_{i}^{n , {m}^{*}} {\sum }_{n} {\sum }_{m ∈ pb} {x}_{k}^{n , m} {x}_{k}^{n , {m}^{*}}}} \} & [ Equation 9 ] \\ {IOC}^{′} = [ \begin{matrix}{IOC}_{11} & {IOC}_{21} & … & {IOC}_{1 N} & {IOC}_{1 ( N + 1 )} \\ {IOC}_{21} & {IOC}_{22} & … & {IOC}_{2 N} & {IOC}_{2 ( N + 1 )} \\ … & … & … & … & … \\ {IOC}_{N 1} & {IOC}_{N 2} & … & {IOC}_{N N} & {IOC}_{N ( N + 1 )} \\ {IOC}_{( N + 1 ) 1} & {IOC}_{( N + 1 ) 1} & … & {IOC}_{( N + 1 ) 1} & {IOC}_{( N + 1 ) ( N + 1 )}\end{matrix} ] & [ Equation 10 ]\end{matrix}$$

In this instance, in an N+1^{th} row and column of Equation 10, IOC_{(N+1)(N+1)} may be ‘1’, and each of remaining IOCs excluding the IOC_{(N+1)(N+1)} may be an IOC calculated between the downmix signal and the object to be added based on Equation 9. Also, the remaining IOCs excluding the IOC_{(N+1)(N+1)} may be identical to each other.

Also, the object information controlling unit 231 may calculate power information for each object using the downmix signal and the OLD extracted from the object information extracting unit 210, and may control the OLD using the power information for each object and power of an inputted object signal. In this instance, the object information controlling unit 231 may receive power of the downmix signal from the downmix controlling unit 222.

In this instance, the power of each object in the predetermined sub-band of the predetermined frame may be calculated as given below.

First, the downmix controlling unit 222 may calculate the power of the downmix signal by summing up each power of the objects included in the object information as given in Equation 11 below.

pₒ_{₁}+pₒ_{₂}+pₒ_{₃}+ . . . +pₒ_{_{N}}=p_{d} [Equation 11]

In this instance, when an n^{th} object is assumed to have a greatest power, an OLD of each object may be calculated as given in Equation 12 in the multi-object audio coding unit 110. In this instance, the object information controlling unit 231 may calculate the power of each object based on Equation 13 as given below.

$$\begin{matrix}{OLD}_{1} = \frac{{p}_{{o}_{1}}}{{p}_{{o}_{n}}} , {OLD}_{2} = \frac{{p}_{{o}_{2}}}{{p}_{{o}_{n}}} , \\ {OLD}_{3} = \frac{{p}_{{o}_{3}}}{{p}_{{o}_{n}}} , … , {OLD}_{N} = \frac{{p}_{{o}_{N}}}{{p}_{{o}_{n}}} & [ Equation 12 ] \\ {p}_{{o}_{1}} = {p}_{{o}_{n}} \cdot {OLD}_{1} , {p}_{{o}_{2}} = {p}_{{o}_{n}} \cdot {OLD}_{2} , \\ {p}_{{o}_{3}} = {p}_{{o}_{n}} \cdot {OLD}_{3} , … , {p}_{{o}_{N}} = {p}_{{o}_{n}} \cdot {OLD}_{N} & [ Equation 13 ]\end{matrix}$$

Also, the object information controlling unit 231 may calculate the power of the n^{th} object pₒ_{ₙ} based on Equation 14 as given below, and may calculate each power of remaining objects by substituting pₒ_{ₙ} to Equation 13 as given above.

$${p}_{{o}_{n}} = \frac{{p}_{d}}{{\sum }_{i = 1}^{N} {OLD}_{i}} \qquad [ Equation 14 ]$$

Particularly, the object information controlling unit 231 generates Equation 15 by substituting Equation 13 to Equation 11, and the object information controlling unit 231 modulates Equation 15 to Equation 16 based on pₒ_{ₙ} that is the power of the n^{th} object.

$$\begin{matrix}{p}_{{o}_{n}} \cdot {OLD}_{1} + {p}_{{o}_{n}} \cdot {OLD}_{2} + {p}_{{o}_{n}} \cdot {OLD}_{3} + … + {p}_{{o}_{n}} \cdot {OLD}_{N} = {p}_{d} & [ Equation 15 ] \\ ( {\sum }_{i = 1}^{N} {OLD}_{i} ) {p}_{{o}_{n}} = {p}_{d} & [ Equation 16 ]\end{matrix}$$

Subsequently, the object information controlling unit 231 may apply Equation 17 as given below to a power of the added object and the power of each object, and may generate an OLDᵢ that is a controlled OLD.

$${OLD}_{i} = \frac{{p}_{{o}_{i}}}{{p}_{{o}_{m}}} , i = 1 , 2 , 3 , … , N + 1 \qquad [ Equation 17 ]$$

In this instance, pₒ_{ₘ} may be a greatest power of an object among the power of the added object and power of each object, and may be a power of m that satisfies Equation 18 as given below.

$$m = {arg}_{i} \{ max ( {p}_{{o}_{i}} ) \} \qquad [ Equation 18 ]$$

Also, the object information controlling unit 231 may simply calculate the DMG and the DCLD with respect to the added object and may add the calculated DMG and the DCLD to the bit stream.

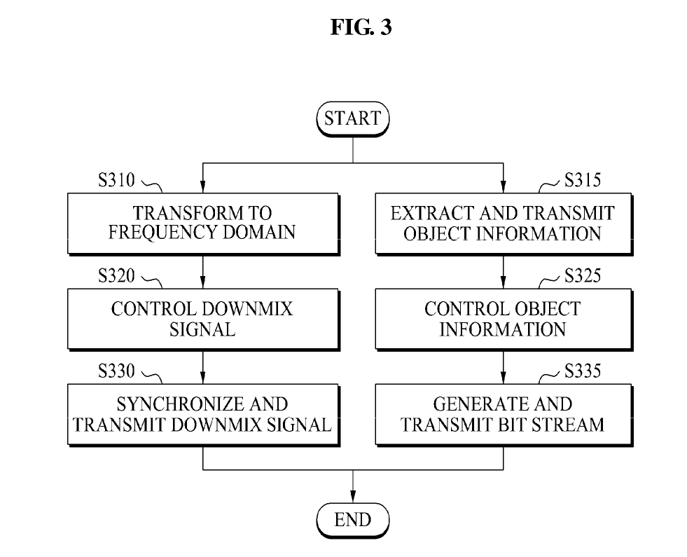

FIG. 3 is a flowchart illustrating an audio object editing method in a multi-object audio coding apparatus according to an embodiment of the present invention.

In operation S310, the frequency analyzing unit 221 transforms a downmix signal received from the multi-object audio coding unit 110 to a downmix signal of a frequency domain, and transmits the downmix signal of the frequency domain to the downmix controlling unit 222.

In operation S315, the object information extracting unit 210 extracts object information from an object bit stream received from the multi-object audio coding unit 110, and transmits the extracted object information to the downmix controlling unit 222 and the object information controlling unit 231. Also, the object information extracting unit 210 may transmit the object bit stream received from the multi-object audio coding unit 110 to the bit stream outputting unit 232.

In operation S320, the downmix controlling unit 222 may edit, namely, correct, add, delete, or substitute, a predetermined object signal by using object editing information and the object information received in operation S315, to generate a controlled downmix signal of the frequency domain.

In this instance, the predetermined signal may be a signal included in the downmix signal of the frequency domain transmitted in operation S310.

In operation S325, the object information controlling unit 231 may control the object information received in operation S315, according to the object editing information. Particularly, the object information controlling unit 231 may delete a part of the object information received in operation S315, may add contents of the object editing information, and may correct contents of the object information received in operation S315 according to the contents of the object editing information.

In operation S330, the frequency synthesizing unit 223 may generate a controlled downmix signal by transforming the controlled downmix signal of the frequency domain to the controlled downmix signal, and may transmit the controlled downmix signal.

In operation S335, the bit stream outputting unit 232 may generate a controlled bit stream by synthesizing the object information controlled in operation S325 and the bit stream transmitted in operation S315, and may transmit the controlled bit stream.

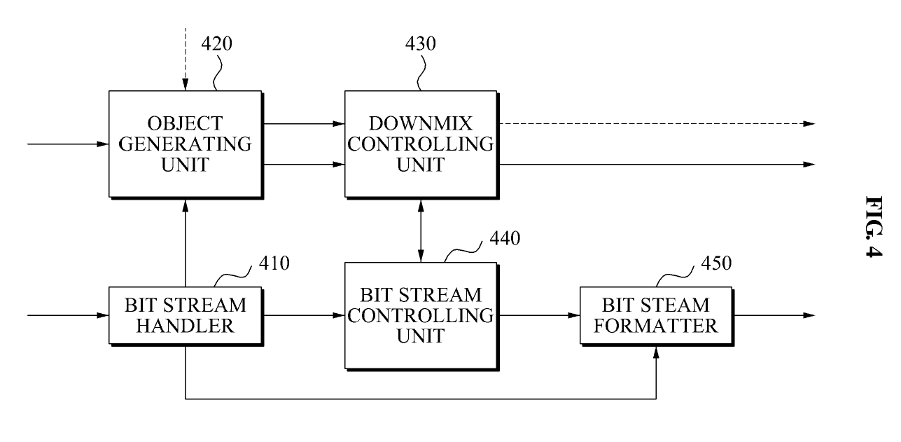

FIG. 4 is a diagram roughly illustrating an audio object editing apparatus in a multi-object audio coding apparatus according to another embodiment of the present invention.

Referring to FIG. 4, the audio object editing apparatus in a multi-object audio coding apparatus according to another embodiment of the present invention is an apparatus of editing an object in a multi-object audio coding apparatus having a Two to N (TTN) structure, and includes a bit stream handler 410, an object generating unit 420, a downmix controlling unit 430, a bit stream controlling unit 440, and a bit stream formatter 450.

The bit stream handler 410 may receive an object bit stream, and may extract, from the object bit stream, a background object (BGO) bit stream indicating background music and a foreground object (FGO) bit stream indicating a predetermined object signal. Also, the bit stream handler 410 may transmit the received object bit stream to the bit stream formatter 450.

The object generating unit 420 may receive a downmix signal, and may generate a BGO downmix signal and an FGO by using the received downmix signal, the BGO bit stream and the FGO bit stream received from the bit stream handler 410. In this instance, the object generating unit 420 may generate an FGO and a BGO similar to an original sound based on a residual signal, when a residual signal is inputted.

The downmix controlling unit 430 may control the BGO downmix signal and the FGO generated by the object generating unit 420, according to object editing information, and may mix the controlled BGO downmix with the controlled FGO to generate a controlled downmix signal.

As an example, when the object editing information is correction information, the downmix controlling unit 430 may perform mixing again after multiplying corrected BGO or FGO by a factor α indicating a degree of control.

Also, when the object editing information is deletion information, the downmix controlling unit 430 may perform mixing again after multiplying an FGO where information corresponding to the deletion information is deleted by the factor α indicating the degree of control. In this instance, the downmix controlling unit 430 may not perform deletion with respect to the BGO.

Also, when the object editing information is addition information, the downmix controlling unit 430 may generate the controlled downmix by mixing the BGO, the FGO, and an object to be added.

In this instance, since deletion and addition of the object is simultaneously performed with respect to the FGO, the downmix controlling unit 430 may generate the controlled downmix signal by mixing an existing BGO and another FGO substituting the FGO to be deleted.

Also, the downmix controlling unit 430 may extract the residual signal again by using the controlled BGO downmix signal, the controlled FGO, the BGO bit stream, and the FGO bit stream, when the residual signal is inputted to the object generating unit 420.

In this instance, the object editing information is correction information, the downmix controlling unit 430 may extract the residual signal by using the FGO/BGO controlled by the downmix controlling unit 430, the controlled downmix signal generated using the controlled FGO/BGO, and an object bit stream edited by the bit stream controlling unit 440. Particularly, the residual signal may generate the FGO and the BGO again by using the controlled downmix signal and an edited object parameter, and may extract a difference between the generated FGO and BGO and the controlled FGO and BGO prior to the downmix, as the residual signal.

Also, when the object editing information is the correction information, the downmix controlling unit 430 may not extract the residual signal.

Also, when the object edition information is addition information, the downmix controlling unit 430 may generate the residual signal by using an object signal to be added and other object signals, downmix signals thereof, and the edited object bit stream. Particularly, the downmix controlling unit 430 may restore the object to be added and the other object signals using the downmix signal generated by addition of the object and the edited object bit stream, and may extract a difference between the restored object signals and the object signals prior to the downmix, as the residual signal.

The bit stream controlling unit 440 may edit the BGO bit stream and FGO bit stream received from the bit stream handler 410, according to the object editing information.

In this instance, since the bit stream controlling unit 440 may edit the BGO bit stream and the FGO bit stream according to the object editing information in the same manner as the object information controlling unit 231, detailed description for operations of the bit stream controlling unit 440 will be omitted.

The bit stream formatter 450 may generate a controlled bit stream by synthesizing the FGO bit stream and the BGO bit stream edited by the bit stream controlling unit 440 with the object bit stream transmitted from the bit stream handler 410, and may transmit the controlled bit stream.

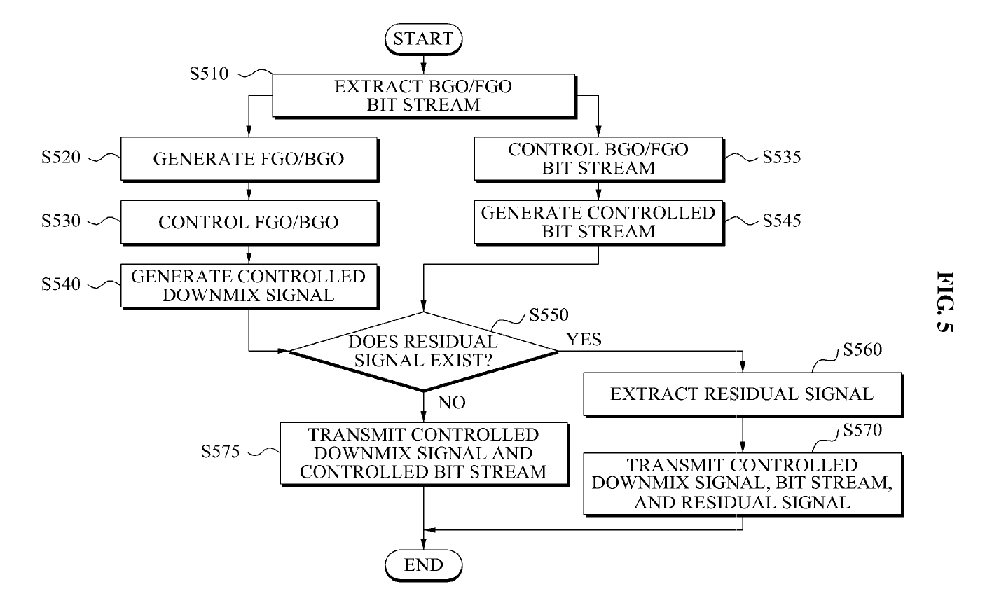

FIG. 5 is a flowchart illustrating an audio object editing method in a multi-object audio coding apparatus according to another embodiment of the present invention.

In operation S510, a bit stream handler 410 receives an object bit stream, and extracts, from the object bit stream, a BGO bit stream indicating a background music and an FGO bit stream indicating a predetermined object signal. Also, the bit stream handler 410 may transmit the received object bit stream to a bit stream formatter 450.

In operation S520, the object generating unit 420 receives a downmix signal, and generates a BGO downmix signal and an FGO bit stream by using the received downmix signal, the FGO bit stream and the BGO bit stream received from the bit stream handler 410.

In operation S530, the downmix controlling unit 430 controls the BGO downmix signal and the FGO generated by the object generating unit 420, according to an object editing information.

In operation S535, the bit stream controlling unit 440 edits the FGO bit stream and the BGO bit stream received from the bit stream handler 410, according to the object editing information.

In operation S540, the downmix controlling unit 430 generates a controlled downmix signal by mixing the controlled BGO downmix signal and the controlled FGO of operation S530.

In operation S545, the bit stream formatter 450 generates a controlled bit stream by synthesizing the edited BGO bit stream and the edited FGO bit stream of operation S535 with the object bit stream transmitted in operation S510.

In operation S550, the downmix controlling unit 430 determines whether a residual signal is inputted to the object generating unit 420.

In operation S560, the downmix controlling unit 430 extracts the residual signal by using the controlled BGO downmix signal of operation S530, the controlled FGO of operation S530, the controlled BGO bit stream of operation S535, and the controlled FGO bit steam of operation S530.

In operation S570, the downmix controlling unit 430 transmits the controlled BGO downmix signal of operation S540 and the residual signal generated in operation S560, and bit stream formatter 450 transmits the controlled BGO bit stream and the controlled FGO bit stream of operation S545.

In operation S575, the downmix controlling unit 430 transmits the controlled BGO downmix signal of operation S540, and the bit stream formatter 450 transmits the controlled BGO bit stream and the controlled FGO bit stream of operation S545.

The audio object editing apparatus in the multi-object audio coding apparatus edits an existing object signal by using a multi-object bit stream and a downmix signal which are generated by coding with respect to multiple objects in a multi-object audio decoding unit, without another coding process, thereby enabling edit of an audio object without having an original object signal. Also, a coding process with respect to the object to be edited is omitted, thereby decreasing complexity.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An audio object editing apparatus in a multi-object audio coding apparatus, the apparatus comprising:
an object information extracting unit to receive an object bit stream and to extract object information from the object bit stream;
a downmix processing unit to receive a downmix signal, and to control the downmix signal using object editing information and the object information; and
a bit stream processing unit to edit the object information according to the object editing information, and to generate a controlled object bit stream based on the edited object information.

2. The apparatus of claim 1, wherein the downmix processing unit comprises:
a frequency analyzing unit to transform the downmix signal to a downmix signal of a frequency domain;
a downmix controlling unit to edit a predetermined object signal included in the downmix signal of the frequency domain by using the object editing information and the object information to generate a controlled downmix signal of the frequency domain; and
a frequency synthesizing unit to transform the controlled downmix signal of the frequency domain to a controlled downmix signal.

3. The apparatus of claim 1, wherein the object information includes at least one of an object level difference (OLD) and an inter-object correlation (IOC) among the object information, the OLD being a value indicating a difference in size between objects and the IOC being a value indicating a correlation between the objects.

4. The apparatus of claim 3, wherein, when the object editing information is correction information for correcting an object, the downmix processing unit changes an OLD of the object corresponding to the correction information based on the correction information, and controls a downmix signal according to a ratio between an OLD accumulated value based on the changed OLD and an accumulated OLD value of prior to the change.

5. The apparatus of claim 4, wherein the accumulated OLD value is a sum of each OLD of multiple objects included in a frame.

6. The apparatus of claim 5, wherein, when the object editing information is deletion information for deleting an object, the downmix processing unit changes an OLD of the object corresponding to the deletion information from among all OLDs into ‘0’, and controls a downmix signal according to a ratio between an OLD accumulated value using the changed OLD and an OLD accumulated value prior to the change

7. The apparatus of claim 3, wherein, when the object editing information is addition information that includes an object to be added, the downmix processing unit controls a downmix signal by mixing the addition information with the downmix signal.

8. The apparatus of claim 3, wherein the bit stream processing unit comprises:
an object information controlling unit to edit the object information according to the object editing information; and
a bit stream outputting unit to generate a controlled bit stream by synthesizing the object information controlled by the object information controlling unit with the bit stream.

9. The apparatus of claim 8, wherein, when the object editing information is correction information, the object information controlling unit changes the OLD based on the correct information.

10. The apparatus of claim 8, wherein, when the object editing information is deletion information, the object information controlling unit deletes an OLD of an object corresponding to the deletion information from among all OLDs, changes each remaining OLD of remaining objects, and deletes at least one IOC related to the object corresponding to the deletion information from among all IOCs.

11. The apparatus of claim 8, wherein, when the object editing information is addition information, the object information controlling unit generates a controlled OLD and a controlled IOC based on the addition information, and changes the OLD and the IOC of prior to the change to the controlled OLD and the controlled IOC.

12. The apparatus of claim 11, wherein the downmix processing unit calculates power information for each object using the downmix signal and the OLD, and generates the controlled OLD using power information for each object and power of an object signal included in the addition information.

13. An audio object edition apparatus in a multi-object audio coding apparatus, the method comprising:
a bit stream handler to receive an object bit stream, and to extract, from the object bit stream, a background object (BGO) bit stream indicating a background music and a foreground object bit stream indicating a predetermined object signal;
an object generating unit to receive a downmix signal, and to generate a BGO downmix signal and a foreground object (FGO) using the BGO bit stream, the FGO bit stream, and the downmix signal;
a downmix controlling unit to control the BGO downmix signal and the FGO according to object editing information, and to generate a controlled downmix signal by mixing the controlled BGO downmix signal and the controlled FGO;
a bit stream controlling unit to edit the BGO bit stream and the FGO bit stream according to the object editing information; and
a bit stream formatter to generate a controlled bit stream by synthesizing the BGO bit stream and the FGO bit stream which are edited by the bit stream controlling unit.

14. The apparatus of claim 13, wherein, when a residual signal is inputted to the object generating unit, the downmix controlling unit extracts the residual signal again using the controlled BGO downmix signal, the controlled FGO, the edited BGO bit stream, and the FGO bit stream.
